(19) United States
(12) Patent Application Publication
(10) Pub. No.: US 2006/0247863 A1
(43) Pub. Date: Nov. 2, 2006

(54) Optimizing maldi mass spectrometer operation by sample plate image analysis

(76) Inventor: Huy A. Bui, Fremont, CA (US)

Correspondence Address: THERMO FINNIGAN LLC, 355 RIVER OAKS PARKWAY, SAN JOSE, CA, 95134, US

(21) Appl. No.: 11/116,830

(22) Filed: Apr. 28, 2005

(51) Int. Cl. G06F 19/00; G06K 9/00

(52) U.S. Cl. 702/19; 702/22; 382/128

(57) ABSTRACT

A method and apparatus are described for performing image analysis of a sample target area on a MALDI sample plate to select laser impingement locations for optimal mass spectra acquisition. The target area image is captured and analyzed to determine the incidence distribution of picture element values (representative of luminance and/or chrominance information). A dynamic threshold value may be determined by constructing a virtual histogram and then identifying a value at which a local minimum occurs between modes of a bimodal distribution. The threshold value is applied to the picture elements to locate regions within the target area that possess desired visual characteristics, such as a high luminance indicative of a crystalline structure. Mass spectra acquisition may be optimized by directing the laser beam to impinge at only those regions that possess the desired visual characteristic. The mass spectrometer performance may be further improved by coupling the image analysis process to an auto-spectrum filtering technique, whereby the laser beam is selectively held at or moved from a region of the sample spot based on whether the resultant mass spectrum meets predetermined performance criteria.

### BACKGROUND OF THE INVENTION

1. Field of the Invention

The present invention is related to mass spectrometers, and more specifically to MALDI mass spectrometers and methods for operating the same.

2. Description of the Prior Art

In recent years, matrix assisted laser desorption/ionization (MALDI) mass spectrometry, a technique that provides minimal fragmentation and high sensitivity for the analysis of a wide variety of fragile and non-volatile compounds, has become widely used. The MALDI technique may be combined with a variety of mass analyzers, such as time-of-flight (TOF) analyzers, Fourier Transform/Inductive Coupled Resonance (FTICR) analyzers, quadrupole ion traps, and single or triple quadrupoles, to provide for detection of large molecular masses. The MALDI technique may be used to determine molecular weights of biomolecules and their fragment ions, monitor bioreactions, detect post-translational modifications, and perform protein and oligonucleotide sequencing, for tissue imaging, and many more applications.

The MALDI technique involves first mixing the analyte with a liquid solvent containing a matrix, which is a compound or ligand that may be co-crystallized with the analyte, and which is strongly absorbent at the laser wavelength. A MALDI sample spot is prepared by depositing a droplet of the analyte/matrix/solvent solution at a defined sample target area on a sample plate, and then permitting the solution to dry. The sample plate will typically have a large number of spaced apart target areas (wells) arranged in a rectilinear array, and deposition of the solvent droplets at the defined target areas may be effected manually or by employing an automated deposition apparatus (sometimes referred to as an “auto-spotter”). As the solvent evaporates, the matrix and analyte will co-crystallize on the sample plate surface. Due to the complex nature of the crystallization process, the resultant samples can be quite inhomogeneous, with areas of high matrix and analyte density and other areas of low or zero density coexisting within a target area. Furthermore, some regions may contain matrix molecules but be absent of analyte molecules. The crystal geometry and analyte distribution will vary according to the identity of the matrix material; for example, DHB (2,5-dihydrobenzoic acid) is known to yield elongated crystals having matrix/analyte unevenly distributed, the analyte location in the crystals being compound and concentration dependent, whereas α-CHA (α-cyano-4-hydroxycinnamic acid) produces compact crystals having uniform matrix/analyte densities. There may also be errors in the positioning of the sample spot at the target region arising from malfunction or operational limitations of the automated deposition apparatus that result in samples that are offset from the center of the target area.

Once the solvent has evaporated, the sample plate containing the sample spots is inserted into the mass spectrometer and the sample at each target area is analyzed by directing a intense pulsed laser beam onto selected regions within the target area. The laser energy is absorbed by the matrix, resulting in sublimation of the matrix crystals and expansion of the matrix into the gas phase, which entrains intact analyte molecules into an expanding plume. Analyte ions are thereafter directed through ion optics and into the mass analyzer.

Typically, the laser beam area, as defined by the intersection of the laser beam with the sample plate, is considerably smaller than the diameter of the sample spot, and data obtained from multiple laser pulses directed at different regions of the sample spot are used to analyze the sample. Sample spot regions can be selected for irradiation with the laser manually, by viewing an image of the sample with a high magnification video system, or automatically by moving the laser or sample plate through a series of predefined positions (such as spiral or zig-zag paths) that cover the target area that is expected to contain the sample spot. Manually selecting regions within the target area typically requires the full time attention of a skilled operator and is generally not amenable to automation. Automatically moving the laser focal point or the sample plate so that the laser beam focuses on predefined regions within in the sample spot can lead to data sets where the laser pulse has missed the sample completely due to inhomogeneity of the sample spot within the target region. This can result in poor data quality or significantly extended analysis times as the number of laser shots for each target area is increased to ensure that adequate data is acquired.

Various techniques have been proposed in the prior art for optimizing the MALDI process by locating regions within the target area that yield or are predicted to yield strong analyte signals. Such regions are referred to colloquially as “sweet spots”, and techniques intended to locate such regions are referred to as “sweet-spot hunting.” Two notable sweet-spot hunting techniques are disclosed in U.S. Pat. No. 6,804,410 by Lennon et al. and U.S. Pat. App. Pub. No. 2004/0183006 by Reilly et al. Lennon et al. discloses an image processing method whereby regions of high brightness are located within the sample spot (indicative of the presence of an analyte-containing crystal) via subtraction of pixels from the image having a brightness level less than a minimum value. Groups of pixels having brightness levels exceeding the minimum are analyzed to locate clusters, and the laser may be directed to impinge the target area at the center of such clusters. Reilly et al. discloses the use of a “survey scan”, which involves directing the laser beam onto a specified region of the sample spot and determining whether the resultant mass spectrum meets certain predetermined performance criteria representative of a strong analyte signal. If the performance criteria are met (indicating that the region represents a sweet spot), the location of the region is recorded for use in a subsequent detailed scanning routine (or, alternatively, detailed scanning of the sweet spot and adjoining areas may be performed during the survey scan). If the mass spectrum obtained at the specified region fails to meet the performance criteria, the location of the region is not recorded and the laser beam is advanced to a different region of the sample spot. The survey scan may be performed, for example, by moving the laser beam from region to region in a logarithmic spiral pattern.

WHILE the foregoing techniques may offer significant benefits, there remains a need in the MALDI mass spectrometer art for more effective techniques for identifying and utilizing sample spot regions that yield strong analyte signals and produce high-quality mass spectra.

### SUMMARY OF THE INVENTION

According to one aspect of the invention, there is provided a method for processing images of sample spots deposited on a sample plate for analysis in a mass spectrometer. The method involves capturing an image of at least a portion of a target area on which a sample spot has been deposited. The image is stored as an array of picture elements, each of which has associated image data values representative of luminance and/or chrominance. A dynamic threshold value is determined by examining the incidence of image data values for picture elements in the image, and the threshold value is applied to the picture elements to locate regions having desired image characteristics such as brightness or color.

In accordance with specific embodiments of the invention, a representation of the incidence of image data values is constructed by providing a virtual histogram consisting of a plurality of bins, each bin corresponding to a range of image data values; and allocating each picture element to a bin in accordance with its image data. The threshold value is determined by identifying the bin which exhibits a local minimum of incidence, corresponding to a valley interposed between peaks of a bi-modal distribution, and setting the threshold value to a value within the range represented by the bin at which the local minimum occurs. In another specific embodiment, an image is captured at a first set of illumination parameters and then analyzed by the histogram construction technique to identify a local minimum. If the local minimum is not readily identifiable, another image may be acquired under at a second, different set of illumination parameters and analyzed to identify the local minimum. This process may be repeated under varying illumination conditions until a clearly identifiable local minimum is produced.

According to another specific embodiment of the invention, application of the threshold value to the picture elements may involve determining, for each picture element, whether the image data value is at least as great as the threshold value. Those picture elements having image data values that do not meet the threshold value are flagged as “bad” picture elements. A path may then be generated through regions of the target area corresponding to those picture elements that meet the threshold. The path may be generated by applying a path rule set that includes priority rules based on image data values (e.g., luminance values), distances between picture elements, and edge and other parameters representative of the distribution of “good” picture elements (those meeting the threshold value) within the target area. Application of the rule set may involve calculating a ranking value (e.g., a value in the range of 0-1) indicative of the probability that the region corresponding to the picture element contains an operationally significant amount of analyte material. The path rule set may be selected from a plurality of candidate path rule sets based on user-supplied information, such as the identity of the matrix material. In some embodiments, a data mining engine may be provided to adapt the path rule sets (or the schemes for selection thereof) based on previously obtained mass spectral data such that the identification of regions that yield high quality mass spectra is rendered more reliable.

In accordance with another aspect of the invention, a method for operating a MALDI mass spectrometer is provided. The method includes steps of capturing an image of at least a portion of a target area on which a sample is deposited, and calculating a dynamic threshold value based on the incidence of picture element values in the image. Regions of the target area are selectively irradiated based on whether the value of image data of the corresponding picture element of the image is at least equal to the threshold value. To improve performance, the image analysis technique may be combined with an auto-spectrum filtering technique to provide more efficient data acquisition, whereby the laser beam is selectively held at or moved from a region of the target area based on whether the resultant mass spectrum meets predetermined performance criteria.

In accordance with another aspect of the invention, a MALDI mass spectrometer apparatus is provided. The apparatus includes a sample plate that is positionable relative to a laser beam, and a laser configured to irradiate a region of a sample spot disposed on a target area of the sample plate so as to cause some of the analyte molecules in the sample to be desorbed and ionized. The apparatus further includes a mass analyzer and ion optics for transporting at least a portion of the analyte ions to the mass analyzer. A processing unit analyzes an image of a target area acquired by an imaging device to dynamically determine a threshold value, which may involve construction of a virtual histogram representing image data incidence, and applies the threshold value to picture elements of the image. The processing unit, through control of the positioning mechanism, causes regions of the sample spot to be selectively irradiated based at least partially on whether the value of image data of the corresponding picture element of the image is at least equal to the threshold value. The processing unit may also determine whether the resultant mass spectrum meets predetermined performance criteria, and based on this determination either continue irradiation of the selected region or cause a different region to be irradiated.

### BRIEF DESCRIPTION OF THE DRAWINGS

FIG. 1 is a schematic depiction of a MALDI mass spectrometer;

FIG. 2 is an illustration is a fragmentary top view of a portion of a sample plate, showing sample spots deposited in target areas on the plate;

FIG. 3 is a flowchart depicting the steps of a method for analyzing an image of a sample spot to locate regions having desired characteristics, in accordance with an aspect of the invention;

FIG. 4 is a schematic depiction of the aggregation of pixels into picture elements;

FIG. 5 is a histogram depicting the incidence of picture element data values in a first image, the histogram exhibiting a local minimum between modes;

FIGS. 6(a) and 6(b) are histograms depicting the incidence of pixel data values in second and third images, wherein no local minimum is present;

FIGS. 7(a) and 7(b) depict two examples of picture element maps obtained by application of the dynamic threshold to the picture element data;

FIGS. 8(a)-(d) depict examples of paths generated through thresholded picture elements based on different path generation rule sets;

FIG. 9 is a flowchart depicting the steps of a method for applying an auto-spectrum filter, in accordance with a second aspect of the invention; and

FIG. 10 depicts data flow into routines used for thresholding and path generation.

### DETAILED DESCRIPTION OF EMBODIMENTS

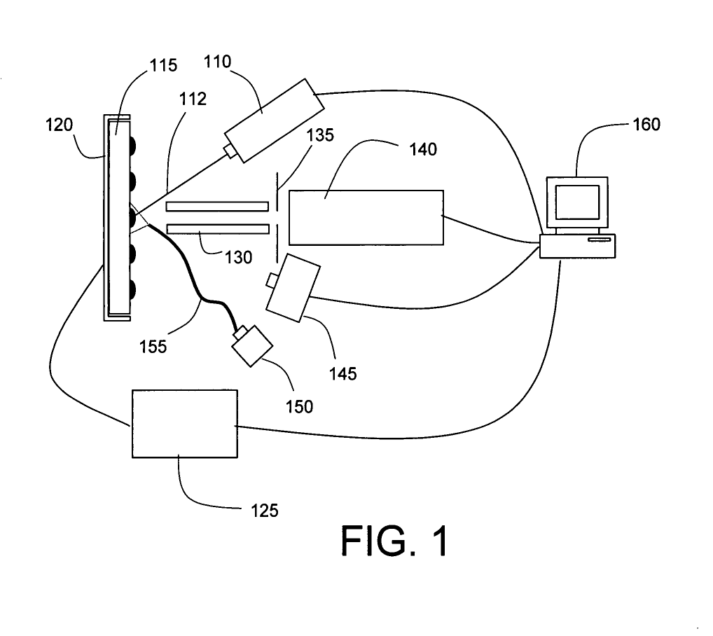

An overall configuration of a mass spectrometer (MS) system 100 according to one aspect of the present invention is illustrated schematically in FIG. 1. As shown, MS system 100 includes a laser 110 positioned to direct a pulsed beam of radiation 112 onto a sample spot deposited on sample plate 115. A sample plate holder 120 is provided with a positioning mechanism, such as an X-Y stage, to align the laser spot (the impingement area of the laser beam) with a selected region of sample plate 115. Sample plate holder 120 is typically positioned in the X-Y plane (the plane defined by sample plate 115) by means of stepper motors or similar actuators, the operation of which is precisely controlled by signals transmitted from controller 125. In alternate configurations, alignment of the laser spot with a selected region of sample plate 115 may be achieved by maintaining the sample plate 115 stationary and steering laser beam 112 by moving the laser or mirrors or other optical elements disposed in the laser beam path.

Ions produced via absorption of the laser beam energy at the sample spot are transferred by ion optics such as quadrupole ion guide 130 though one or more orifice plates or skimmers 135 into a mass analyzer device 140 for measurement of the ions' mass-to-charge ratios. The mass analyzer device 140, which is located in a high-vacuum chamber, may take the form, for example, of a TOF analyzer, quadrupole analyzer, ion trap, or FT/ICR analyzer. Typically, the ions will pass through one or more chambers of successively lower pressures separated by orifice plates or skimmers, the chambers being differentially pumped to reduce total pumping requirements. For the purpose of clarity, the chamber walls, intermediate ion optics, and pumps have been omitted from the drawings.

MS system 100 is additionally provided with a sample plate imaging system, comprising an imaging device 145 positioned to capture an image of regions of the sample plate, and an illumination source 150 for illuminating the imaged region. Imaging device 145, which may take the form of a conventional video camera having a set of CCD sensors for detecting light reflected from the imaged region, generates data representative of the imaged region. The image data is organized into an array of pixels, wherein each pixel has image data in the form of a set of values representative of luminance and/or chrominance information for the corresponding image area. In one example, the image is divided into an array 480 pixels high by 640 pixels wide. For an imaging device in the form of a black-and-white camera, each pixel may have a single 8-bit value (i.e., in the range of 0-255) representative of luminance. In an alternative implementation where color images are captured, each pixel has three 8-bit values representative of both luminance and chrominance information; such data will typically be formatted in accordance with the Y-U-V or R-G-B standards. Lenses and/or other focusing elements may be positioned in the imaging path to provide the desired degree of magnification. In one implementation, each pixel corresponds to a region on the sample plate of approximately 7 μm square.

Illumination source 150 may be a laser or other single-wavelength source, or may emit radiation across a broad spectrum of wavelengths. In a typical embodiment, radiation emitted by illumination source 150 will be in the visible spectrum, but alternative embodiments may utilize an illumination source which emits light at other wavelengths (e.g., in the near-infrared band) that can be detected and imaged by imaging device 145. As will be discussed in further detail below, it is beneficial to provide means for controlling parameters of the illuminating radiation (i.e., intensity, wavelength, and polarization) so that the image analysis process may be optimized. Control of such parameters may be accomplished by modulating operation of the illumination source 150, or by controlling adjustable optical elements (e.g., attenuators or filters) in the beam path. Light emitted by illumination source 150 may be delivered to the region to be imaged through an optical fiber 155, which obviates the need to provide mirrors and/or other beam redirecting or focusing elements.

Imaging device 145, controller 125, laser 110, and illumination source 150 communicate with and are controlled by processing unit 160. Processing unit 160 may be a general purpose computer equipped with suitable software for performing the required control and processing operations, but may alternatively take the form of an ASIC or other-special purpose processor. Processing unit 160 will typically include or be coupled to I/O devices for entering and displaying information, including keyboards, mice, video monitors, and the like, and will be further provided with volatile and/or non-volatile memory or storage devices for storing and retrieving data. One or more suitable interface cards or ports, such as a frame grabber card, may be utilized to enable communication between processing unit 160 and imaging device 145, controller 125, laser 110 and illumination source 150. As will be described in further detail hereinbelow, processing unit 160 will preferably provide for the input (for example, through a graphical user interface) and storage of user-specified parameters, such as matrix type, matrix concentration, analyte type and analyte concentration. This information may be used, among other things, to select an appropriate path rule set for generating an optimized path between regions of the target area that are predicted to yield strong analyte signals. Processing unit 160 may be further provided with a data mining engine, which adjusts path rule sets based on the correlation of image data and other parameters with mass spectrum data. The operation of the data mining engine will be described more fully below.

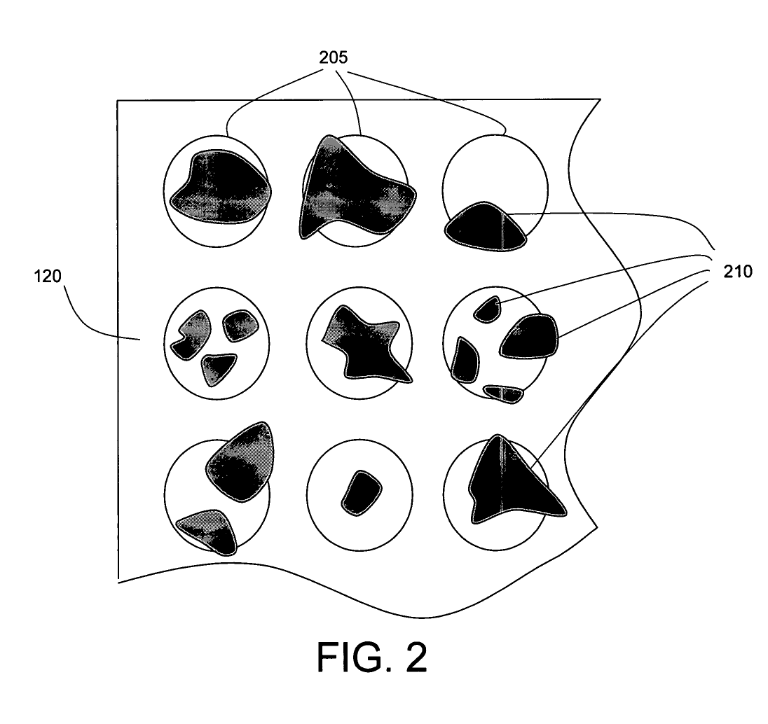

FIG. 2 is a fragmentary top view of sample plate 150. An array of target areas 205 are arranged on the top surface of sample plate 150. Various standards for the number, size, arrangement and spacing of the target areas are known in the art; in a widely used standard, a total of 96 target areas are arranged into a grid of twelve columns by eight rows. Droplets of the analyte/matrix/solvent solution are typically deposited at or near the target area centers by an automated deposition apparatus. As discussed above and depicted in FIG. 2, the complex and nature of the crystal formation process may produce sample spots 210 that are irregularly shaped, are eccentrically placed with respect to the target area, or are formed into two or more discontinuous spots separated by gaps. An objective of the present invention is to locate, via image analysis, regions of high analyte/matrix density within the target areas so that laser beam 112 is preferentially directed onto such regions, thereby yielding high-quality mass spectra.

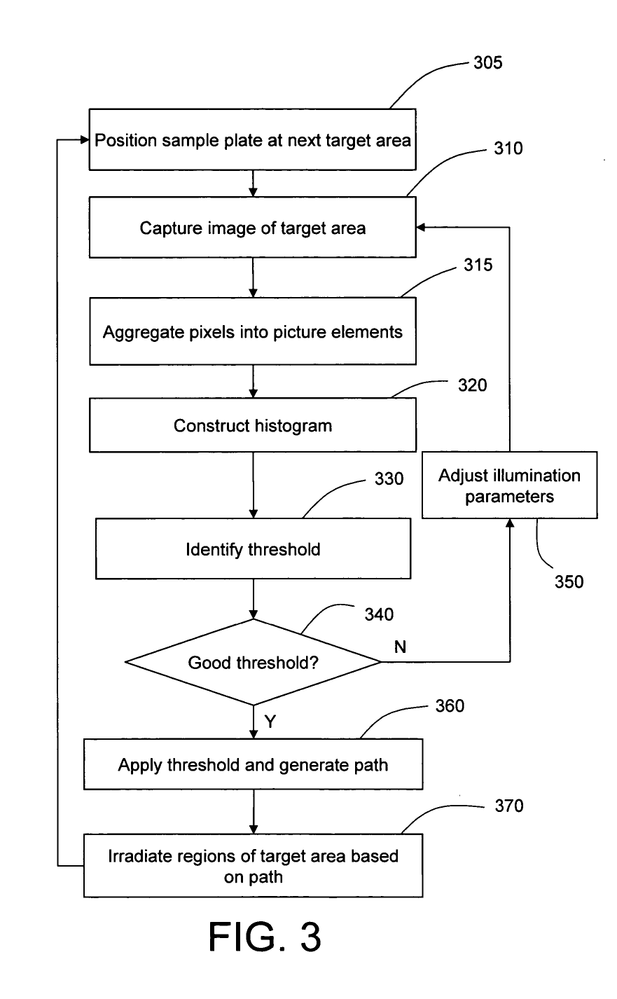

A technique for implementing image analysis in accordance with an embodiment of the invention is depicted in flowchart form in FIG. 3. In an initial step 305, sample plate 120 is positioned by controller 125 such that the image viewed by imaging device 150 is centered at or near the center of a selected target area. Position data representative of target area centers may be prestored in processing unit 160, or may alternatively be generated during a calibration process initiated when sample plate 120 is loaded into the vacuum lock chamber of MS system 100. After the positioning step 305 has been completed, an image of the target area is captured by imaging device 150 and stored at processing unit 160, step 310. As discussed above, the image will be stored as pixel data corresponding to an array of contiguous pixels, with each pixel representing a spatially distinct region of the image. The number of pixels in the image is determined by the resolution of the imaging device sensor, and the physical area occupied by each pixel depends on the image magnification. The data for each pixel consists of a set of values representative of luminance and/or chrominance by the pixel. For ease of explication, we will assume that each pixel has a single value corresponding to luminance, for example a single 8-bit value, wherein the pixels have integer values falling in a range extending between 0 (lowest brightness level) and 255 (highest brightness level). However, in certain implementations, both luminance and chrominance data (or chrominance data alone) will be acquired and stored for each pixel and used to perform the thresholding operations discussed below.

In some configurations of MS system 100, objects (such as ion guide 130) lying in the imaging path may partially obscure the view of the target area such that a complete image of the target area cannot be acquired while sample plate 120 is held in a fixed position. One solution to this problem is to create a composite image derived from multiple images obtained at different viewpoints. This may be accomplished, for example, by acquiring a first image in which a portion of the target area is obscured, displacing sample plate 120 in the X- and/or Y-direction so that the obscured portion of the target area is visible, acquiring a second image, and then stitching the two images together using known image processing techniques. Depending on the instrument geometry and degree to which the image is obscured, it may be necessary to acquire and stitch together several images taken at different viewpoints in order to produce a composite image in which all of the target area is visible.

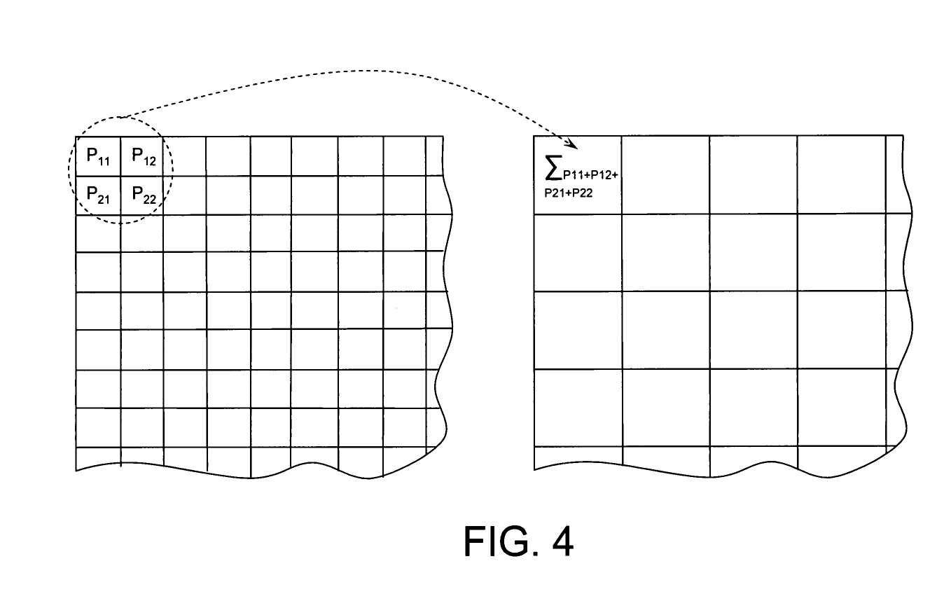

In step 315, groups of pixels in the image are aggregated into superpixels (referred to herein as “picture elements”). The dimensions of the picture element are set such that the size of the picture element is roughly equal to the laser spot size. In an exemplary implementation, the laser spot has a diameter of about 100 μm, and each picture element is aggregated from a 14.3-by-14.3 array of pixels having dimensions of about 7 μm square (noting that the picture elements may be formed from partial pixels, if appropriate). One method for aggregating the pixels is to simply sum the pixel values (e.g., luminance values) for a block of pixels of predetermined size and to assign the sum to the spatially corresponding picture element. FIG. 4 depicts an aggregation of a two-by-two block of pixels into a picture element. For many applications, relatively higher numbers of pixels will be aggregated. It should be noted that if a summing technique is used, the range of possible picture element values will be equal to the number of pixels in the block multiplied by the range of values for each pixel: a picture element composed of an eight-by-eight block of pixels each having a single eight-bit value will have a value in the range of 0-16,320 (i.e, a 14-bit value).

It should be further noted that the pixel aggregation step is optional, and may not be necessary or desirable in cases where the image area represented by each pixel is comparable in scale to the laser beam impingement area. In such cases each picture element may consist of a single pixel.

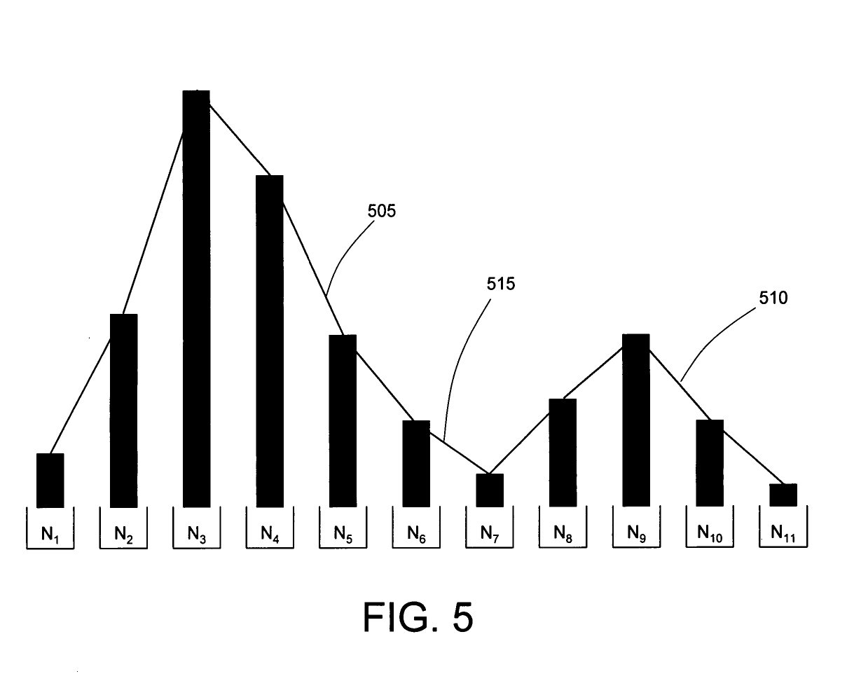

Next, in step 320 the picture element values are analyzed to determine the incidence of values in the image. In the current example, the values are luminance values in the range of 0-255. The incidence of values may be analyzed by constructing a virtual histogram, as depicted in FIG. 5. To construct the histogram, the range of possible picture element values is divided into a plurality of discrete subranges that collectively span the entire range, each range being represented by a bin Nᵢ. While a relatively small number of bins (11) are depicted in the figures, typical implementations may use a significantly greater number of bins. The histogram resolution (determined by the number of bins) may be set automatically or specified manually by a user. Processing unit 160 executes a routine wherein it allocates each picture element to the appropriate bin based on the picture element's value. Each bin Nᵢ has a counter that is incremented when a picture element is allocated to the bin.

After all of the picture elements have been allocated to the proper bins, the bin counters are analyzed to locate the bin at which the picture element value incidence displays a local minimum, step 330. As shown in FIG. 5, the distribution of pixel values will typically fall into a bimodal distribution, consisting of a first peak 505 spanning relatively low luminance values and a second peak 510 spanning relatively high luminance values. The low luminance values of the first peak 505 correspond to regions of the image where light-reflecting, high analyte concentration crystals are absent (e.g., areas of bare sample plate) or in low abundance. Conversely, the high luminance values in the second peak 510 correspond to regions of the image where the crystals are present. The first and second peaks are separated by a valley, indicated as 515 on the figure. In one implementation, the dynamic threshold value is set to the midpoint of the range assigned to the bin at which the local minimum (i.e., the lowest point in valley 515) occurs. Taking the example depicted in FIG. 5, the local minimum occurs at bin N₇. Assuming that bin N₇ represents picture element values of 7000-8000, the dynamic threshold value may be set to the midpoint of this range, or 7500. In essence, the dynamic threshold value delineates picture element values occurring at regions having no or negligible amounts of analyte-containing material from those picture element values occurring at regions having significant amounts of analyte-containing materials.

The histogram construction step 320 may be implemented in a recursive manner to improve the accuracy and reliability of the dynamic threshold determination. According to one variation of this step, an initial histogram is constructed using a set of bins having picture element values extending between preset minimum and maximum values. Next, a range of interest is established by examining the bin counters to identify lower and upper picture element values outside of which the incidence is zero or minimal. For example, the initial histogram may be constructed using one hundred bins N₁ . . . N₁₀₀, wherein N₁ represents picture element values of 0-100, N₂ represents picture element values of 101 to 200, and so on. After allocation to the bins, it may be found that bins N_{1 to N}₂₅ and N₇₆ to N₁₀₀ are empty or contain minimal numbers of picture elements. A range of interest is then defined between the values represented by bins N₁₆ to N₇₅, and a second “stretched” histogram is constructed by assigning new pixel values to bins N₁ . . . N₁₀₀ such that only the range of interest is represented and each bin spans a narrower range of values relative to the initial histogram e.g., bin N₁ is assigned picture element values of 2400-2450, bin N₂ is assigned picture element values of 2451-2500, and so on. Stretching the histogram may produce greater resolution between the two peaks and allow more precise determination of the dynamic threshold value.

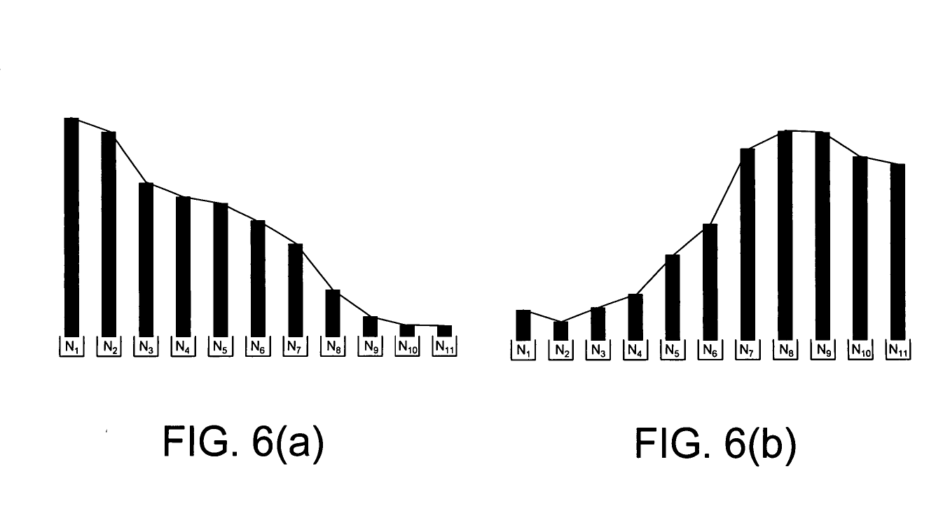

It will be recognized that the reliability of the dynamic threshold determination process is dependent upon the selection of suitable illumination parameters, such as illumination source 150 intensity, wavelength(s), and polarization. If, for example, the illumination source intensity is inadequate or excessive, the histogram constructed from the picture element values will not exhibit the bimodal distribution discussed above and depicted in FIG. 5, but may instead take the form of a poorly resolved hump without a clearly identifiable local minimum. This situation is represented by the histograms shown in FIGS. 6(a) and 6(b). More specifically, the FIG. 6(a) histogram represents the case where the illumination source intensity is inadequate, and the FIG. 6(b) histogram represents the case where the illumination source intensity is excessive. Because the dynamic threshold value cannot be reliably determined from such a histogram, in the event that it is determined in step 340 that a good (clearly identifiable) threshold value is not present, it may be necessary to adjust the illumination source parameters appropriately (e.g., by increasing or decreasing intensity, changing the wavelength(s), or rotating polarization) per step, reacquire the image, and process the reacquired image in accordance with steps 350 and 310-340. The reacquisition process may be repeated under different sets of illumination conditions until a histogram having the desired properties (i.e., a clearly multimodal distribution) is achieved. In certain implementations of the invention, the method may involve automatically acquiring and processing (via histogram construction) images at a prespecified set of varying illumination conditions, and then selecting for thresholding the image that yields the “best” (i.e., most clearly bimodal) picture element value incidence distribution.

It will be further recognized that other implementations of the present invention may involve determination of multiple threshold values, each threshold value being determined based on the incidence of a different part of the picture element data. For example, for an application in which picture element data values are derived from pixel data stored in YUV format, a first dynamic threshold value may be determined based on the luminance data (derived from the Y-values), and a second dynamic threshold value may be determined based on the chrominance data (based on the U- or V-values).

Next, the determined threshold value is applied to the picture element values, step 360. In its simplest implementation, this step may involve comparing each picture element value to the threshold value and returning a single-bit value of 0 or 1 depending on whether the picture element value is less than or equal to/greater than the threshold value. Alternatively, this step may involve storing a value equal to the difference between the picture element value and the threshold value. Still alternatively, the step may involve storing the picture element value for picture elements that meet the threshold, and an arbitrary flag value (e.g., −1) for picture elements that have values below the threshold. Other implementations may involve a more complex comparison. For example, as discussed above, the threshold determination process may produce two or more different threshold values determined from image analysis, with one threshold corresponding to luminance data and the other(s) corresponding to chrominance data. In this situation, the thresholding step 360 may involve comparing each one of a set of picture element values to the corresponding threshold value and then ANDing the results to determine if all of the thresholds are met. In another example, the thresholding step may yield a range of values depending on the amount by which the picture element value exceeds the threshold value. In the most general sense, application of the threshold value classifies the picture elements into “good” picture elements that exhibit the desired brightness and/or other spectral characteristics and “bad” picture elements that lack these characteristics. In this manner, regions of the target area that have high sample concentrations and which are more likely to produce good mass spectra may be identified.

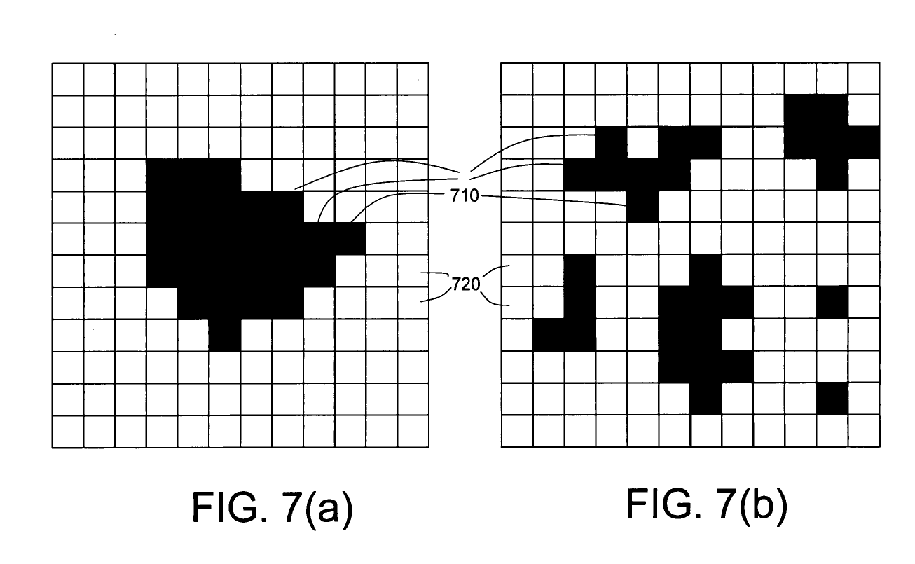

FIGS. 7(a) and 7(b) present examples of processed target area images after application of a thresholding step that yields a binary (good/bad) result. Good picture elements 710 are darkly shaded and bad picture elements 720 are unshaded. As may be discerned by inspection of the figures, the good picture elements 710 may be concentrated in a central region of the target area (as shown in FIG. 7(a)), or may form more complex patterns such as several widely distributed clusters (as shown in FIG. 7(b)).

Those skilled in the art will recognize that various additional image processing operations, such as clustering or low-pass filtering, may be applied to the image data prior or subsequent to the thresholding step in order to remove “noisy” data that may result in erroneous identification of good and/or bad picture elements or otherwise improve selection of picture elements corresponding to regions likely to produce strong analyte signals. For example, stray good picture elements, i.e., isolated good picture elements having no neighboring good picture elements, may be more likely to result from noisy data and may be beneficially omitted from the laser path. Other well-known image processing techniques, such as edge detection, may also be applied to the image data to eliminate or select picture elements having undesirable or desirable properties, e.g., to select only those picture elements that are proximate to an edge of a cluster of picture elements that meet the threshold value.

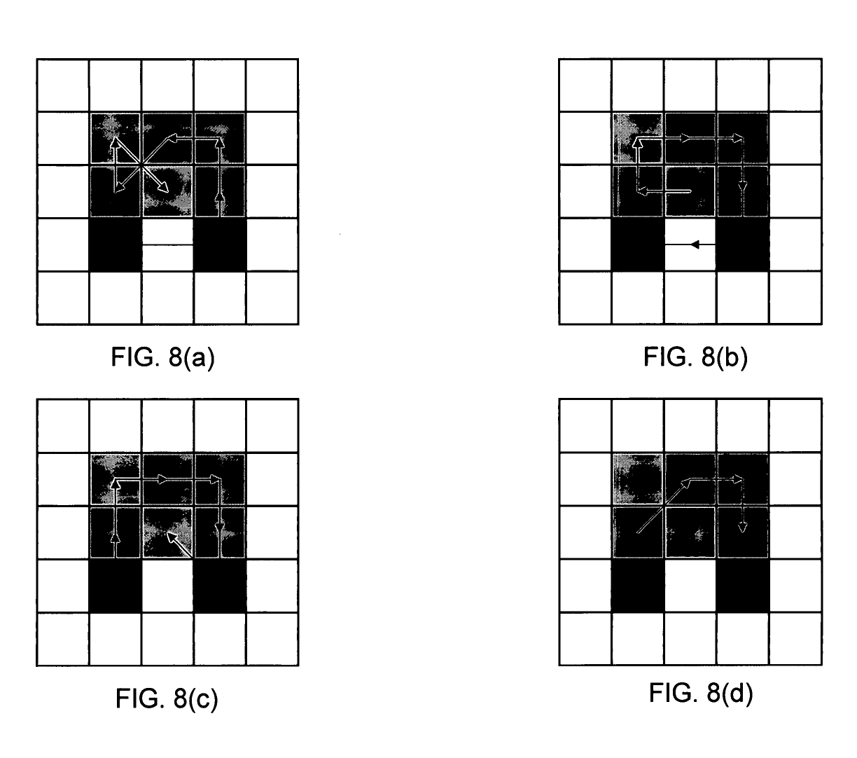

The processed target area image data may be stored as a data structure, referred to herein as a thresholded picture element map, that includes, for each picture element, location data representative of the position of the region occupied by the picture element and a thresholded data value (which could be a one-bit value, or could be a value within a continuous range of values) indicative of whether the picture element value meets the threshold value. The thresholded picture element map may further include parameters calculated from the image data, such as edge parameters (which may be calculated by determining luminance value gradients) describing a picture element's proximity to the edge of a cluster. The thresholded picture element map may then be utilized to select which regions in the target area are to be irradiated by laser 110. In a simple implementation, the laser spot is stepped between regions of the target area along a standard predetermined path (such as a zigzag or spiral path). Those regions that correspond to good picture elements are irradiated by the laser beam to produce mass spectra, while regions corresponding to bad picture elements are skipped without being irradiated, step 370. This process continues until all regions corresponding to good picture elements have been irradiated. One example of a path generated through regions corresponding to good picture elements is depicted in FIG. 8.

Greater efficiencies and improved performance may be obtained by utilizing a path generation technique based on application of an appropriate path rule set. Examples of paths generated through regions of a target area corresponding to good picture elements in accordance with different path rule sets are depicted in FIGS. 8(a)-(d). Generally speaking, each path rule set will specify the parameters to be considered in constructing the path and the relative priority of these parameters. The parameters will typically include the picture element data values and relative positioning between picture elements/region, and may further include other parameters such as an edge parameter unshaded regions correspond to picture elements having values less than the dynamically-determined threshold value, lightly shaded regions correspond to picture elements having values that exceed the threshold value by a relatively small amount, medium shaded regions correspond to picture elements having values that exceed the threshold value by a moderate amount, and darkly shaded regions correspond to picture elements having values that exceed the threshold value by a relatively large amount. FIG. 8(a) depicts a path generated through regions of a target area where the path rule set specifies that the picture element value is assigned first priority, and distance between successively irradiated regions is assigned second priority. Thus, in FIG. 8(a), the darkly shaded regions are irradiated first, followed by the medium shaded regions, and then the lightly shaded regions.

FIG. 8(b) depicts a path generated through the target area where the path rule set assigns highest priority to distance between successively irradiated regions, and disregards the differences in picture element values for regions corresponding to picture elements that meet the threshold value. In accordance with application of this path rule set, an outward spiral patterned path is developed.

FIG. 8(c) depicts a path generated through the target area where the path rule set assigns first priority to regions corresponding to picture elements located near the edge of the cluster (i.e., those having edge parameters corresponding to areas of high picture element value gradients), and second priority to the picture element values. Application of this path rule set yields a path that first traces the edge of the shaded region and then turns inward.

Finally, FIG. 8(d) depicts a path generated through the target area where the path rule set is configured to select for irradiation only those regions corresponding to picture elements having values falling between a minimum and maximum value (these values should be distinguished from the dynamic threshold value determined by image analysis). Such values may be fixed, or may be developed automatically by correlation of previously obtained mass spectral data with picture element values.

It is noted that the foregoing examples are intended as illustrative, rather than limiting, and that any number of path rule sets could be developed based on various parameters.

It is further noted that in certain embodiments of the invention, the threshold application and path generation steps may be integrated into a combined step, indicated as step 360 in FIG. 3. In other words, it is not necessary for the purposes of the invention that comparison of each picture element value to the threshold value be performed prior to initiating the path generation routines.

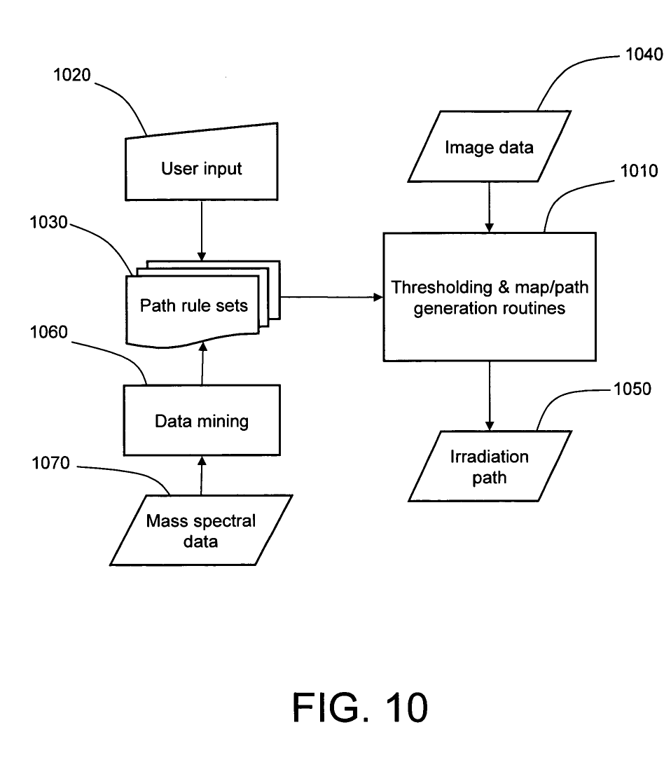

FIG. 10 depicts exemplary information flow into the thresholding/path generation routines 1010 that apply the thresholding and path generation algorithms to the picture element data. User-supplied parameters 1020 are used to select the appropriate path rule set from a plurality of established path rule sets 1030. For example, each path rule set may uniquely correspond to a user-supplied combination of matrix and analyte type. Alternatively, the path rule set may be directly selected by the user. Each path rule set may be implemented in the form of a lookup table that specifies a set of weighting factors that reflects the relative priority of certain parameters (picture element, e.g., luminance value, distance, edge parameter). The weighting factors for the selected path rule set are passed to the thresholding/path generation routines and applied to the image data 1040 to generate an optimized path 1050 through regions of the target area.

A data mining engine 1060 may be provided to adapt the path rule sets 1030 to continually improve MS system 100 performance. Generally described, data mining engine correlates previously acquired image data 1040 with mass spectral data 1070 and adjusts the weighting factors (or adds or deletes weighting factors) in path rule sets 1030 accordingly. Correlation may be performed after each scan or at periodic intervals. If the mass spectral data indicates that a particular parameter of the image data 1040 correlates particularly strongly with the resultant analyte signal, then data mining engine 1060 will adjust upwardly the weighting factor associated with that parameter; conversely, if the parameter correlates particularly weakly with the analyte signal, then data mining engine will revise the associated weighting factor downwardly. The path rule adaptation may be based only on data previously acquired for sample spots on the same MALDI plate, or may include data acquired for similar sample types on previously analyzed MALDI plates.

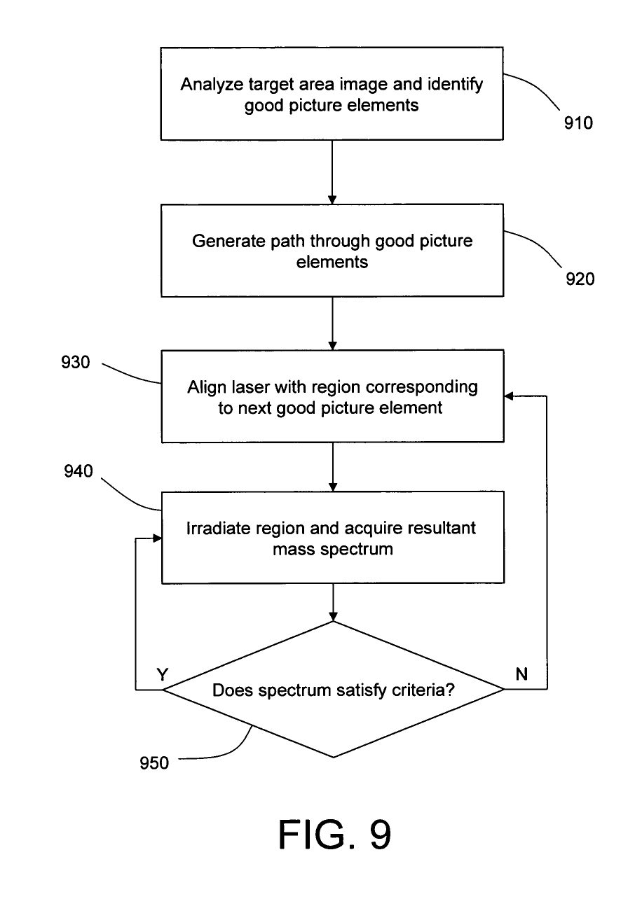

The performance of MS system 100 may be further optimized by combining the image analysis technique described above with an auto-spectrum filtering technique, in which the laser beam is selectively held at or moved from a region of a sample spot based on whether the mass spectrum obtained at that region meets predetermined criteria indicative of a strong analyte signal. An example of an auto-spectrum filtering technique is depicted in the FIG. 9 flowchart. In the initial step 910, the target area image is acquired and analyzed to determine the dynamic threshold and to identify the good picture elements. This step may be conducted in accordance with the method depicted in FIG. 3 and described above. Processing unit 160 may then generate a path linking the good picture elements using the appropriate path generation routines, step 920.

Processing unit 160 then sends the appropriate signals to controller 125 to cause the controller to position sample plate 115 such that a region corresponding to the first good picture element in the path is aligned with the laser spot, step 930. The laser 110 then irradiates the selected region (typically by emitting a predetermined number of pulses, or “shots”), resulting in the desorption and ionization of analyte molecules from the sample/matrix crystals, step 940. The analyte ions are conveyed by ion guide 130 into mass analyzer 140, which separates the analyte ions (or their product ions, if an ion fragmentation process is effected) according to their mass-to-charge ratio. One or more detectors associated with mass analyzer 140 generate signals representative of ion abundance. These signals (or data derived therefrom) are conveyed to processing unit 160, which produces a mass spectrum of the analyte ions emitted from the selected region.

Next, in step 950, processing unit 160 analyzes the mass spectrum to determine if it meets prespecified performance criteria. The criteria may include one or more of several parameters commonly employed in the mass spectrometry art to characterize mass spectra quality, including without limitation peak height (intensity), peak area, signal-to-noise ratio, or summed signal intensity. If the mass spectrum satisfies the performance criteria, the laser spot location is held stationary, and processing unit 160 continues to acquire mass spectra by directing laser 110 to repeatedly irradiate the selected region. This process may be repeated until a predetermined number of laser pulses have been directed onto the selected region, or until subsequent spectra obtained at the selected region fail the specified performance criteria.

In the event that processing unit 160 determines that the mass spectrum does not meet the performance criteria, MS system 100 stops acquiring mass spectra at the selected region, and processing unit 160 directs controller 125 to move sample plate 115 such that the laser spot is aligned with the region corresponding to the next good picture element in the path, per step 930. The method then proceeds to step 940, with the changed region being irradiated and the resulting mass spectrum being analyzed to determine, based on whether the mass spectrum meets the performance criteria, whether the changed region will continue to be irradiated or the sample plate will be repositioned to the next location specified by a good picture element.

In an alternative implementation, the image analysis of the invention may be coupled with the survey scan process described in the aforementioned U.S. Pat. App. Pub. No. 2004/0183006 by Reilly et al. More specifically, the dynamic threshold-based image analysis technique described above in connection with FIGS. is employed to identify good picture elements, and the processing unit generates a path through the regions of the target area corresponding to the good picture elements. Each region on the path is successively irradiated by laser 110, and the resulting mass spectrum for each region is analyzed to determine if the performance criteria are satisfied. The processing unit then removes from the path all regions that did not produce satisfactory mass spectra. The revised path may then be used for a subsequent analytical scan.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for processing images of sample spots deposited on a sample plate for analysis in a mass spectrometer apparatus, comprising the steps of
acquiring an image of a section of the sample plate, the section including at least a portion of a target area having a sample deposited thereon;
storing the image as an array of picture elements, each picture element having associated image data;
determining a threshold value based on the incidence of values of the image data; and
applying the threshold value to the array of picture elements.

2. The method of claim 1, wherein the step of storing the image includes a step of aggregating arrays of pixels into picture elements.

3. The method of claim 2, wherein the step of aggregating the pixels into picture elements includes summing the image data associated with the pixels.

4. The method of claim 1, wherein the step of determining the threshold value includes steps of:
providing a plurality of bins each corresponding to a range of image data values; and
allocating each picture element to a bin in accordance with the value of the image data of the picture element.

5. The method of claim 1, wherein the step of applying the threshold value includes the steps of, for each picture element:
comparing the value of the image data with the threshold value; and
assigning the picture element a value indicative of whether or not the image data is less than the threshold value.

6. The method of claim 1, wherein the step of determining the threshold value includes the step of identifying a value at which the incidence is at or near a local minimum.

7. The method of claim 1, wherein the step of determining the threshold value includes steps of:
determining whether a local minimum exists in the incidence of image data values; and
if no local minimum exists, adjusting image acquisition parameters and reacquiring the image.

8. The method of claim 7, wherein the step of adjusting imaging parameters includes modulating the intensity of a light source that illuminates the sample plate.

9. The method of claim 1, wherein the step of determining a threshold value comprises determining a plurality of threshold values each corresponding to a different part of the image data.

10. The method of claim 1, wherein the image data comprises luminance data only.

11. The method of claim 1, wherein the step of applying the threshold value includes generating an irradiation path through regions of the target area corresponding to the picture elements.

12. The method of claim 11, wherein the step of generating an irradiation path includes applying a path rule set to the image data.

13. The method of claim 12, wherein the path rule set is selected from a plurality of path rule sets based on user-supplied parameters.

14. The method of claim 12, wherein the path rule set includes a plurality of weighting factors each corresponding to a parameter of the image data.

15. The method of claim 14, wherein the image data includes an edge parameter and the path rule set includes a weighting factor associated with the edge parameter.

16. A method for operating a MALDI mass spectrometer having a sample plate and a plurality of sample spots deposited thereon, comprising steps of:
acquiring an image of a section of the sample plate, the section including at least a portion of a target area having a sample spot deposited thereon;
storing the image as an array of picture elements, each picture element having associated image data;
determining a threshold value based on the incidence of values of the image data; and
selectively irradiating a region of the sample plate depending at least in part on whether the image data of a picture element corresponding to the region on the sample plate is at least as great as the threshold value.

17. The method of claim 16, wherein the step of determining a threshold value includes constructing a histogram by performing the steps of:
providing a plurality of bins each corresponding to a range of image data values;
allocating each picture element to a bin in accordance with the value of the image data of the picture element; and
identifying the bin at which the incidence exhibits a local minimum, and setting the threshold value equal to a value within the range of values assigned to the bin.

18. The method of claim 16, wherein the step of determining the threshold value includes steps of:
determining whether a local minimum exists in the incidence of image data values; and
if no local minimum exists, adjusting image acquisition parameters and reacquiring the image.

19. The method of claim 16, wherein the step of selectively irradiating a region of the sample plate includes a step of generating an irradiation path through regions of the target area corresponding to the picture elements.

20. The method of claim 19, wherein the step of generating an irradiation path includes applying a path rule set to the image data.

21. The method of claim 16, further comprising a step of:
generating a mass spectrum produced by an irradiated region;
determining if the mass spectrum meets predetermined performance criteria; and
if the mass spectrum does not meet the predetermined performance criteria, irradiating a different region of the sample plate.

22. Mass spectrometry apparatus, comprising:
a radiation source configured to emit a radiation beam toward a sample plate, the sample plate having at least one target area on which a sample is deposited;
an imaging device configured to acquire an image of a section of the sample plate, the section including at least a portion of the target area;
a processing unit, coupled to the imaging device, for storing the image as an array of picture elements, each picture element having associated image data, determining a threshold value based on the incidence of values of the image data, and applying the threshold value to the array of picture elements; and
a positioning device, coupled to the processing unit, for adjusting the position of the sample plate relative to the laser beam;
wherein the processing unit controls the positioning device so as to selectively irradiate regions of the target area based on whether the image data of a picture element corresponding to the region on the sample plate is at least as great as the threshold value.

23. The apparatus of claim 22, wherein the processing unit is configured to determine the threshold value by performing the steps of:
providing a plurality of bins each corresponding to a range of image data values;
allocating each picture element to a bin in accordance with the value of the image data of the picture element; and
identifying the bin at which the incidence exhibits a local minimum, and setting the threshold value equal to a value within the range of values assigned to the bin.

24. The apparatus of claim 22, wherein the processing unit is configured to perform the steps of:
determining whether a local minimum exists in the incidence of image data values; and
if no local minimum exists, adjusting image acquisition parameters and reacquiring the image.

25. The apparatus of claim 24, wherein the adjusted image acquisition parameter is the illumination intensity.

26. The apparatus of claim 22, wherein the processing unit is further configured to perform a step of generating an irradiation path through regions of the target area corresponding to the picture elements.

27. The apparatus of claim 26, wherein the step of generating an irradiation path includes applying a path rule set to the image data.

28. The apparatus of claim 22, further comprising a mass analyzer for acquiring a mass spectrum of the irradiated region, and wherein the processing unit is further configured to perform the steps of:
determining if the mass spectrum meets predetermined performance criteria; and
if the mass spectrum does not meet the predetermined performance criteria, causing the positioning device to adjust the position of the sample plate such that a different region of the sample plate is irradiated.
